(19) United States
(12) Patent Application Publication
(10) Pub. No.: US 2009/0248448 A1
(43) Pub. Date: Oct. 1, 2009

(54) CLINICAL NETWORK FOR DERMAL TREATMENTS

(76) Inventors: RONEN ZAKAY, Reut (IL); RON ZAKAI, BJ Zaandam (NL)

Correspondence Address: DANIEL J SWIRSKY, 55 REUVEN ST., BEIT SHEMESH, 99544, IL

(21) Appl. No.: 12/411,520

(22) Filed: Mar. 26, 2009

Related U.S. Application Data
(60) Provisional application No. 61/039,699, filed on Mar. 26, 2008.

(51) Int. Cl. G06Q 50/00

(52) U.S. Cl. 705/3

(57) ABSTRACT

A method and a system for sharing analysis of dermal treatment result, the method comprising: defining treatment data comprising at least two of: a dermal characteristic of a patient, a dermal treatment parameter, and a dermal treatment result; collecting the treatment data at the treatment device and communicating the treatment data to a central network server; analyzing the treatment data at the server, forming analysis result; and providing the analysis result to operators of the dermal treatment devices.

### CROSS-REFERENCE TO RELATED APPLICATIONS

The present application claims priority from U.S. provisional patent application 61/039,699, filed Mar. 26, 2008, the contents of which are hereby incorporated by reference.

### FIELD AND BACKGROUND OF THE INVENTION

The present invention relates to devices and methods for methods and system for dermal treatments and, more particularly, but not exclusively to treatments of the skin using intense pulsed light.

U.S. Pat. No. 6,461,348 is believed to represent the most relevant prior art. U.S. Pat. No. 6,461,348 teaches a photo-thermal epilation apparatus equipped with communication channel that links the apparatus to a remote system via a communication network. According to U.S. Pat. No. 6,461,348, the linking to the remote system provides billing, remote monitoring, updating of system operating software, user training and evaluation, insuring safe and reliable operating procedures, security, etc.

There are many devices available in the market for treating various medical aspects of the skin. Such dermal treatment devices use various technologies such as intense pulsed light, various lasers, radio frequency (RF), direct electric current and ultrasound. For example, dermal treatment devices use light for applications such as hair removal. Such devices may use intense pulsed light, preferably in specific wavelengths, to effect specific skin cells, such as hair roots. The higher concentration of melanin in the hair root, compared to the surrounding tissue, absorbs the light and concentrates the heat in the root of the hair, thus disturbing hair growth. Treatment parameters such as light intensity, treatment duration, etc. are subject to skin characteristics such as the color of the skin, the color of the hair, type of hair, etc. Dermal treatment systems enable the operator to set the treatment parameters or to select a preset treatment program according to the skin characteristics. Eventually, the effectiveness of the treatment depends on the experience gathered by each operator in identifying the skin characteristics and adapting the optimal treatment program and parameters. This experience is never shared and operators are destined to repeat other operators' mistakes and undergo a long learning curve, while causing great discomfort to their patients.

There is thus a widely recognized need for, and it would be highly advantageous to have, a light-based dermal treatment device devoid of the above limitations.

### SUMMARY OF THE INVENTION

According to one aspect of the present invention there is provided a method for sharing analysis of dermal treatment result, the method containing:
defining at least two parameters from a list containing:
   a dermal characteristic of a patient;
   a dermal treatment parameter; and
   a dermal treatment result;
providing a server operative to communicate with a plurality of dermal treatment devices;
accepting, at the server, dermal treatment information, for a dermal treatment applied to a patient, the dermal treatment information containing at least two of:
   the dermal characteristic of the patient;
   the dermal treatment parameter; and
   the dermal treatment result;
analyzing, at the server, the dermal treatment information for a plurality of medical treatments, to form an analysis result; and
providing the analysis result to a user of the dermal treatment device.

According to another aspect of the present invention there is provided a method for sharing analysis of dermal treatment result wherein the dermal characteristic of a patient contains at least one of:
a patient identification;
a parameter identifying a skin type;
a parameter identifying a skin color;
a parameter identifying a hair color; and
a parameter identifying patients health status;

According to yet another aspect of the present invention there is provided a method for sharing analysis of dermal treatment result wherein the dermal treatment parameter contains at least one of:
a clinic identifying parameter;
an operator identification parameter;
a patient identification parameter;
a treatment identifying parameter;
a dermal treatment system identifying parameter;
a dermal treatment applicator identifying parameter;
a dermal treatment duration parameter;
a dermal treatment intensity parameter;
a pulse count parameter;

According to still another aspect of the present invention there is provided a method for sharing analysis of dermal treatment result wherein the steps of:
defining at least two parameters;
accepting, at the server, dermal treatment information, for a dermal treatment applied to a patient, and
analyzing, at the server, the dermal treatment information;
additionally contains at least one of:
   operator's feedback per session;
   operator's feedback per treatment;
   operator's feedback per patient;
   patient's feedback per session;
   patient's feedback per treatment;
   physician's feedback per session;
   physician's feedback per treatment; and
   physician's feedback per patient.

Also according to yet another aspect of the present invention there is provided a method for sharing analysis of dermal treatment result wherein the step of providing the analysis result to a user of the dermal treatment device contains authenticating the user.

Further according to yet another aspect of the present invention there is provided a method for sharing analysis of dermal treatment result wherein the step of providing the analysis result to a user of the dermal treatment device contains providing the analysis to the user according to access rights predefined for the user.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the present invention involves performing or completing certain selected tasks or steps manually, automatically, or any combination thereof. Moreover, according to actual instrumentation and equipment of embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of a clinical network containing a dermal treatment database hosted by a clinical network server connected via a communication network to a plurality of dermal treatment devices and to multimedia stations;

FIG. 2 is a simplified block diagram of a data structure of the dermal treatment information communicated within the clinical network;

FIG. 3 is a simplified flow chart of a device software program executed by a processor of the dermal treatment device; and

FIGS. 4A and 4B, taken together, are a simplified flow chart of a server software program of the clinical network server.

### DETAILED DESCRIPTION OF THE INVENTION

The present invention in embodiments thereof comprises a clinical network, preferably connecting a plurality of dermal treatment devices with a central database, for collecting treatments data, analyzing the treatments data, and disseminating the results of the analysis of the treatments data.

The principles and operation of the clinical network according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

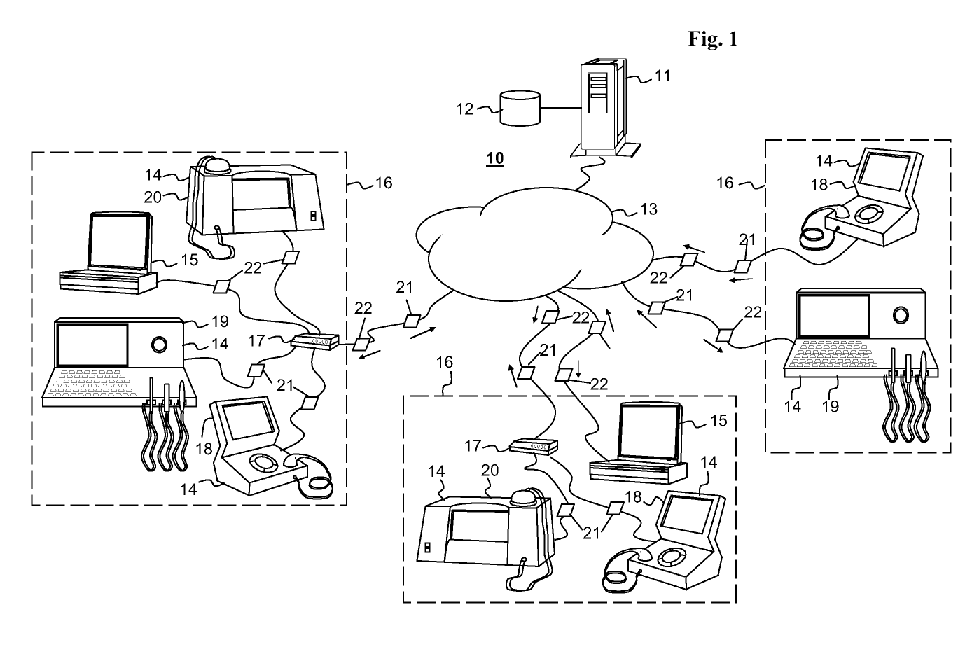

Reference is now made to FIG. 1, which is a simplified illustration of a clinical network 10 according to an embodiment of the present invention.

As seen in FIG. 1 the clinical network 10 preferably contains a clinical network server 11, preferably containing a dermal treatment database 12, connected via a communication network 13 to a plurality of dermal treatment devices 14 and to multimedia stations 15.

It is appreciated that the embodiment of the multimedia station 15 can take the form of a regular personal computer equipped with a special client software and connected to the clinical network server 11 via the communication network 13. Alternatively the multimedia station 15 can take the form of a regular personal computer equipped with a regular Internet browsing software and connected to the clinical network server 11 via the Internet. It is appreciated that a multimedia station or its functions can be integrated into a dermal treatment devices. Therefore, when discussing the functions of a multimedia station it can be understood to be incorporated into a dermal treatment device.

It is appreciated that the communication network 13 can be any of type of wired communication networks such as WAN, MAN or LAN, etc., or a wireless network such as WiMAX, Wifi, UMTS, etc., or their combinations, and including the Internet.

As seen in FIG. 1 the dermal treatment devices 14 are grouped according to customers 16, where each customer, such as a hospital or a clinic, operates several dermal treatment devices 14. Dermal treatment devices 14 of a customer 16 are preferably collocated, and thus may use a local communication concentrator 17, such as a router or a hub, to connect to the communication network 13. It is appreciated that the multimedia station can provide the functionality of the local communication concentrator 17.

As seen in FIG. 1, there are several types of dermal treatment devices 14, such as intense pulse light devices 18, laser devices 19, and ultrasound devices 20. Other types of dermal treatment devices are also possible.

As seen in FIG. 1, the dermal treatment devices 14 send dermal treatment information 21 to the clinical network server 11. The clinical network server 11 stores the dermal treatment information in the dermal treatment database 12, analyzes the collected dermal treatment information and sends dermal treatment updates 22 to the dermal treatment devices 14 and/or to the multimedia stations 15. Alternatively or additionally, the clinical network server 11 posts dermal treatment updates 22 on a web-site to enable dermal treatment devices 14 and/or to the multimedia stations 15 to access the dermal treatment updates 22, preferably selectably, and/or to download the dermal treatment updates 22, preferably selectably.

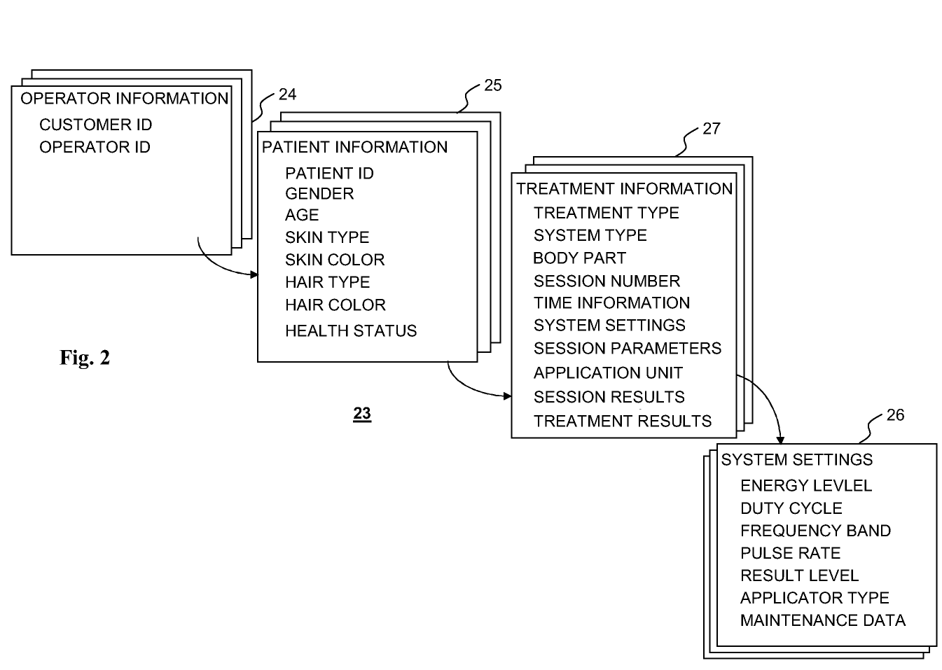

Reference is now made to FIG. 2, which is a simplified block diagram of a data structure 23 of the dermal treatment information 21 according to an embodiment of the present invention.

As seen in FIG. 2, the data structure 23 of the dermal treatment information 21 preferably contains the following components:
operator information 24;
patient information 25;
system information 26; and
treatment information 27;

Preferably, the operator information 24 contains information about the customer and about the person operating the dermal treatment device.

Preferably, the patient information 25 contains information about the patient such as: identification number, gender, age, type and color of the skin, type and color of the hair, health status, etc. Preferably, the patient information 25 excludes indication of the patient's name and similar private information.

Preferably, the system information 26 contains:
information about the medical treatment device 14 used to treat the patient, such as: type if system;
system serial number or similar means of identification;
type if applicator unit (head);
applicator serial number or similar means of identification;
system settings:
maintenance related information such as lamp lifetime;
etc.

Preferably, the treatment information 27 contains information such as: type of treatment, treated body part, system used, and results.

Preferably, the treatment information is generated by the dermal treatment device 14 for each application of the treatment. For example, for hair removal treatment using intense pulsed light, a dermal treatment information 21 is generated for each application of intense pulse light. Each such dermal treatment information 21 includes information about the patient, the session, the body part, and the parameters of the applied intense pulsed light. Additionally the dermal treatment information 21 contains information about the customer, the operator and the device used, including all the system settings.

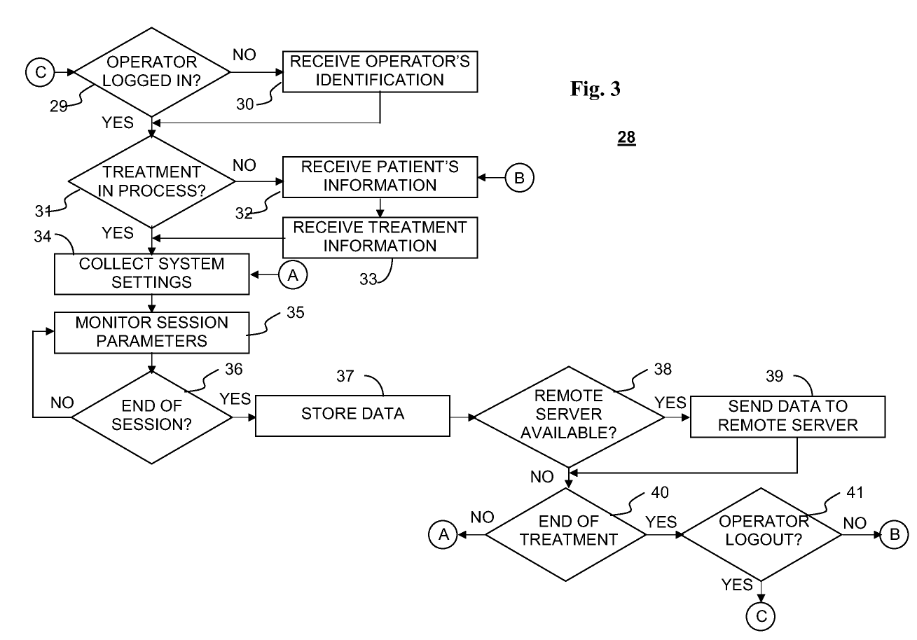

Reference is now made to FIG. 3, which is a simplified flow chart of a device software program 28 executed by a processor of the dermal treatment device 14 according to an embodiment of the present invention.

As seen in FIG. 3, the device software program 28 preferably starts in steps 29 and 30 by logging in the operator of the dermal treatment device 14. The device software program 28 then proceeds to steps 31, 32 and 33 to receive from the operator the details or identification of the patient and the treatment type and protocol. The device software program 28 then proceeds to steps 34 and 35 to collect from the system the system configuration parameters and the application parameters. In this respect, application parameters refer to the operating parameters applied for a single application of the treatment. For example, a single pulse of an intense pulsed light treatment.

When the device software program 28 detects that the session is finished (step 36) the device software program 28 stores the collected information (step 37), and if, or when, the clinical network server 11 is available online (step 38) the device software program 28 send the information to the clinical network server 11 (step 39) in the form of dermal treatment information 21. At the end of the treatment the device software program 28 preferably logs-out the operator (steps 40 and 41).

It is appreciated that treatment parameters are collected repeatedly and/or continuously at least for each application of the selected treatment. The collected treatment parameters can be sent to the clinical network server 11 for each application separately, or collectively for the entire session, or later, for a plurality of session, according to the availability of the clinical network server 11 and according to the configuration of the dermal treatment device 14

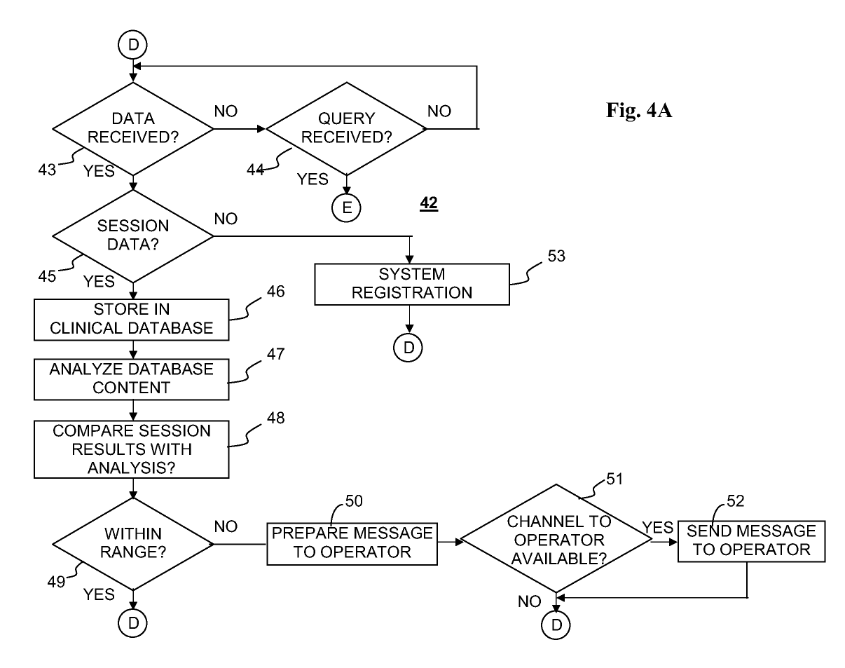

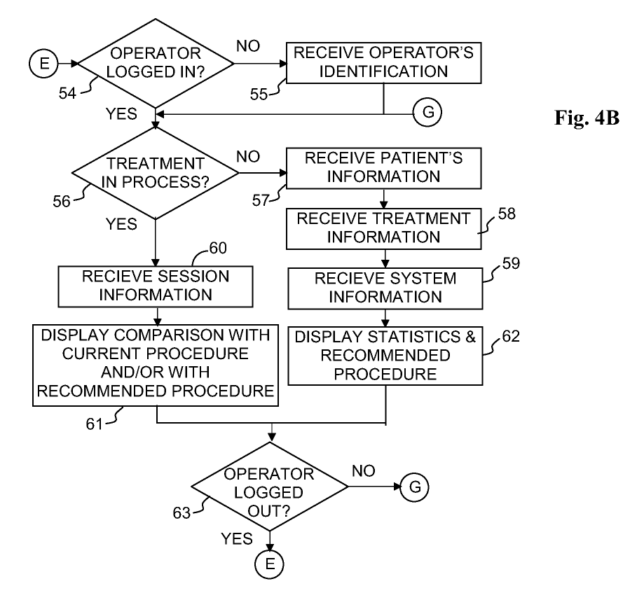

Reference is now made to FIGS. 4A and 4B, which, taken together, are a simplified flow chart of a server software program 42 of the clinical network server 11 according to an embodiment of the present invention. FIG. 4A shows the flow-chart part of the server software program 42 in which the clinical network server 11 receives dermal treatment information 21 from a dermal treatment device 14 and disseminates dermal a treatment update 22. FIG. 4B shows the flow chart of the part of the server software program 42 in which the clinical network server 11 communicates with a multimedia station 15.

As seen in FIG. 4A, the server software program 42 starts with steps 43 and 44 by detecting a dermal treatment information 21 or a query such as for a treatment update 22. If a dermal treatment information 21 is received the server software program 42 proceeds to steps 45 and 46 to arrange the dermal treatment information 21 per session. For example, if dermal treatment information 21 were received for each part of a session, such as for a pulse in a intense pulsed light treatment, then steps 45 and 46 collect the plurality of dermal treatment information 21 for each session and store them together. Alternatively, if dermal treatment information 21 were received for a group of sessions, for example because the clinical network server 11 was not available for the dermal treatment device 14 at the time the sessions were performed, then steps 45 and 46 divides the dermal treatment information 21 into the respective sessions and store them separately.

The server software program 42 preferably proceeds to step 47 to analyze the collection of dermal treatment information 21 to form an analysis result. The server software program 42 preferably proceeds to step 48 to compare the analysis result with the results of the current session. If the session result differs from the expected result, for example, if the session result is outside the range of expected results (step 49) the server software program preferably proceeds to steps 50, 51 and 52 to prepare a message and to send it to the operator in real-time if the dermal treatment device 14 (or a multimedia station 15) is available to receive the message.

Alternatively, step 53 enables the server software program 42 to accept registration information for a newly installed system, a change of configuration parameters, maintenance related information, etc.

Reference is now made to FIG. 4B, which is a simplified flow chart of the part of the server software program 42 in which the clinical network server 11 communicates with a multimedia station 15.

As seen in FIG. 4B, the server software program 42 preferably arrives at step 54 after identifying a query (step 44 of FIG. 4A). If the operator issuing the query is not already logged-in the server software program 42 receives the operator's identification to log-in the operator (step 55). It is appreciated that each operator is assigned authorization to access specific information. Preferably, there is a hierarchical organization of authorization to access information. For example:
a chief administrator can access all information items;
a division administrator can access information related to the professional expertise of the division, such as laser systems;
a distributor or a dealer can access information relating to systems sold or maintained by the specific distributor or dealer;
a customer's administrator can access all information associated with a customer, such as patient data and system data provided by the specific customer;
an operator can access information for a specific patient;
etc.
After the operator is logged-in and assigned the appropriate information access authorization the server software program 42 proceeds to steps 56, 57, 58, 59 and 60 to receive the details of the query such:
as patients information or identification (step 57);
treatment information or identification (step 58);
system information or identification 59;
session information or identification (step 60);
etc.

According to the received information the server software program 42 sends a dermal treatment update 22 to the multimedia station 15 containing, for example:
comparison of the current session or the current procedure with recommended procedures (step 61);
statistics of treatment results and relevant recommended procedures;
recommended procedures and relevant software updates ready for download (step 62);
instructions for operating the system in use and/or recommendations for performing the treatment in session, such as recommended system configuration parameters.

Preferably, the user may interact with the server software program 42 until the user logs-off (step 63).

It is appreciated that the user or operator accessing the clinical network server 11 via the multimedia station 15 or via the dermal treatment devices 14 can perform the following actions:
invoke remote customer support and product maintenance;
View, download and install, preferably automatically, software updates and upgrades;
receive or purchase authorization for new treatments, a basic system may includes basic features and treatments, while other, optional features and treatments are unbundled. Later, the owner of the system can purchase selected additional features or treatments, thus bundling the purchased treatments into the system. Following an online payment such unbundled features become available for the operator of the device immediately.
automatically upload treatment information as each treatment is completed;
receive treatment recommendations;
request service contact.

As described above in accordance with FIGS. 1-4, the clinical network 10, and particularly the clinical network server 11 that preferably enables a user to define a dermal treatment database 12 that contains records that contains parameters such as:
a dermal characteristic of a patient;
a dermal treatment parameter; and
a dermal treatment result;

Preferably, the clinical network server 11 communicates with a plurality of dermal treatment devices 14 and receives from them dermal treatment information 21 for the dermal treatment database 12. The dermal treatment information 21 preferably contains information about dermal treatment applied to a patient such as:
dermal characteristic of the patient;
dermal treatment parameters; and
dermal treatment result;

Preferably, the clinical network server 11 analyzes the dermal treatment information 21 for a plurality of medical treatments, to form an analysis result. The clinical network server 11 then provides the analysis results to users of the clinical network 10 and particularly users of the dermal treatment devices 14.

Additionally, the dermal characteristic of a patient contains patient identification; parameters identifying skin type, parameters identifying skin color, parameters identifying hair color, and parameters identifying patients health status.

Additionally, the dermal treatment information 21 contains:
parameters identifying the clinic, parameters identifying the treatment,
parameters characterizing the dermal treatment device 14,
parameters identifying the applicator unit (head) of the dermal treatment device 14,
parameters characterizing the application unit (e.g. pulse) of the dermal treatment such as intensity, duration, number (e.g. pulse count), etc.

Additionally, the dermal treatment information 21 contains:
operator's feedback per session;
operator's feedback per treatment;
operator's feedback per patient;
patient's feedback per session;
patient's feedback per treatment;
physician's feedback per session;
physician's feedback per treatment; and
physician's feedback per patient.

The clinical network server 11 preferably analyzes the information collected in the dermal treatment database 12, including the parameters listed above, to produce analysis results. Such analysis results typically contain preferred procedures and/or protocol to achieve the required results for a selected treatment according to the characteristics of the patient, such as skin type, skin color, hair type, hair color, age, etc. The preferred procedures and/or protocol typically characterize system settings and treatment parameters such as: intensity, duration, number of applications, etc.

It is expected that during the life of this patent many relevant types of dermal treatments will be developed as well as relevant devices and systems, and the scope of the terms herein, particularly of the terms “network”, “dermal treatment” and “treatment data”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for sharing analysis of dermal treatment result, the method comprising:
defining at least two parameters from a list comprising:
a dermal characteristic of a patient;
a dermal treatment parameter; and
a dermal treatment result;
providing a server operative to communicate with a plurality of dermal treatment devices;
accepting, at said server, dermal treatment information, for a dermal treatment applied to a patient, said dermal treatment information comprising at least two of:
said dermal characteristic of said patient;
said dermal treatment parameter; and
said dermal treatment result;
analyzing, at said server, said dermal treatment information for a plurality of medical treatments, to form an analysis result; and
providing said analysis result to a user of said dermal treatment device.

2. A method for sharing analysis of dermal treatment result according to claim 1 wherein said dermal characteristic of a patient comprises at least one of:
a patient identification;
a parameter identifying a skin type;
a parameter identifying a skin color;
a parameter identifying a hair color; and
a parameter identifying patients health status;

3. A method for sharing analysis of dermal treatment result according to claim 1 wherein said dermal treatment parameter comprises at least one of:
a clinic identifying parameter;
an operator identification parameter;
a patient identification parameter;
a treatment identifying parameter;
a dermal treatment system identifying parameter;
a dermal treatment applicator identifying parameter;
a dermal treatment duration parameter;
a dermal treatment intensity parameter; and
a pulse count parameter;

4. A method for sharing analysis of dermal treatment result according to claim 1 wherein said steps of:
defining at least two parameters;
accepting, at said server, dermal treatment information, for a dermal treatment applied to a patient, and
analyzing, at said server, said dermal treatment information;
additionally comprises at least one of:
operator's feedback per session;
operator's feedback per treatment;
operator's feedback per patient;
patient's feedback per session;
patient's feedback per treatment;
physician's feedback per session;
physician's feedback per treatment; and
physician's feedback per patient.

5. A method for sharing analysis of dermal treatment result according to claim 1 wherein said step of:
providing said analysis result to a user of said dermal treatment device;
comprises authenticating said user.

6. A method for sharing analysis of dermal treatment result according to claim 1 wherein said step of:
providing said analysis result to a user of said dermal treatment device;
comprises providing said analysis to said user according to access rights predefined for said user.
